(19) United States
(12) Patent Application Publication
(10) Pub. No.: US 2008/0310874 A1
(43) Pub. Date: Dec. 18, 2008

(54) Image forming apparatus

(75) Inventor: Yujin Mori, Yokohama-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/213,029

(22) Filed: Jun. 13, 2008

(30) Foreign Application Priority Data
Jun. 13, 2007 (JP) 2007-156111

(51) Int. Cl. G03G 21/14

(52) U.S. Cl. 399/77

(57) ABSTRACT

An image forming apparatus including a controller configured to control each unit of the image forming apparatus, and an engine to which a startup instruction is sent from the controller and a plurality of peripheral devices is connected in series. Power is supplied to the controller and the engine separately, and further supplied to the plurality of peripheral devices from the engine. The engine independently sends startup instructions to the plurality of peripheral devices.

### PRIORITY STATEMENT

The present patent application claims priority from Japanese Patent Application No. 2007-156111, filed on Jun. 13, 2007 in the Japan Patent Office, the entire contents of which are hereby incorporated herein by reference.

### BACKGROUND

1. Technical Field

Example embodiments generally relate to an image forming apparatus including a controller configured to control each unit of the image forming apparatus, and an engine to which a startup instruction is sent from the controller. Power is separately supplied to the controller and the engine. A plurality of peripheral devices is connected to the engine in series, and power is supplied to the plurality of peripheral devices from the engine.

2. Description of the Related Art

Image forming apparatuses such as a copier and a network-compatible image forming apparatus, to which a plurality of peripheral devices such as a sorting unit and a folding unit is connected and that include a power saving mode control unit capable of controlling power consumption of each of the plurality of peripheral devices have been proposed. In such apparatuses, after acquiring an operation mode from each of the plurality of peripheral devices, the image forming apparatuses switch the operation mode to control the power consumption of the plurality of peripheral devices.

However, in such image forming apparatuses, an engine starts the plurality of peripheral devices simultaneously when the image forming apparatuses are started regardless of the number of the peripheral devices connected to the image forming apparatuses. Consequently, a large amount of power is required to initialize the plurality of peripheral devices at a time, exceeding the maximum available power supply.

### SUMMARY

In view of the foregoing, exemplary embodiments provide an image forming apparatus capable of efficiently performing initialization of a plurality of peripheral devices connected thereto.

At least one embodiment provides an image forming apparatus including a controller and an engine. The controller is configured to control each unit of the image forming apparatus. A startup instruction is sent from the controller to the engine, to which a plurality of peripheral devices is connected in series. Power is supplied to the controller and the engine separately, and further supplied to the plurality of peripheral devices from the engine. The engine independently sends startup instructions to the plurality of peripheral devices.

Additional features and advantages of the example embodiments will be more fully apparent from the following detailed description, the accompanying drawings, and the associated claims.

### BRIEF DESCRIPTION OF THE DRAWINGS

A more complete appreciation of example embodiments and the many attendant advantages thereof will be readily obtained as the same becomes better understood by reference to the following detailed description when considered in connection with the accompanying drawings, wherein:

FIG. 1 is a schematic view illustrating an example of a configuration of an image forming apparatus according to exemplary embodiments;

FIG. 2 is a flow chart illustrating steps performed by an engine control unit to start peripheral devices when the image forming apparatus is started;

FIG. 3 is an example of a table for determining a connection type and a startup type of the peripheral devices;

FIG. 4 is a timing chart illustrating an example of start of the peripheral devices when the image forming apparatus is turned on;

FIG. 5 is a timing chart illustrating an example of start of the peripheral devices when the image forming apparatus is restored from a power saving mode;

FIG. 6 is a timing chart illustrating an example of start of the peripheral devices when a startup time is reduced;

FIG. 7 is a timing chart illustrating an example of start of the peripheral devices when a startup type B in the table shown in FIG. 3 is selected; and

FIG. 8 is a timing chart illustrating an example of start of the peripheral devices when a startup type C in the table shown in FIG. 3 is selected.

The accompanying drawings are intended to depict example embodiments and should not be interpreted to limit the scope thereof. The accompanying drawings are not to be considered as drawn to scale unless explicitly noted.

### DETAILED DESCRIPTION OF EXAMPLE EMBODIMENTS

In describing example embodiments illustrated in the drawings, specific terminology is employed for the sake of clarity. However, the disclosure of this specification is not intended to be limited to the specific terminology so selected, and it is to be understood that each specific element includes all technical equivalents that operate in a similar manner and achieve a similar result.

Reference is now made to the drawings, wherein like reference numerals designate identical or corresponding parts throughout the several views.

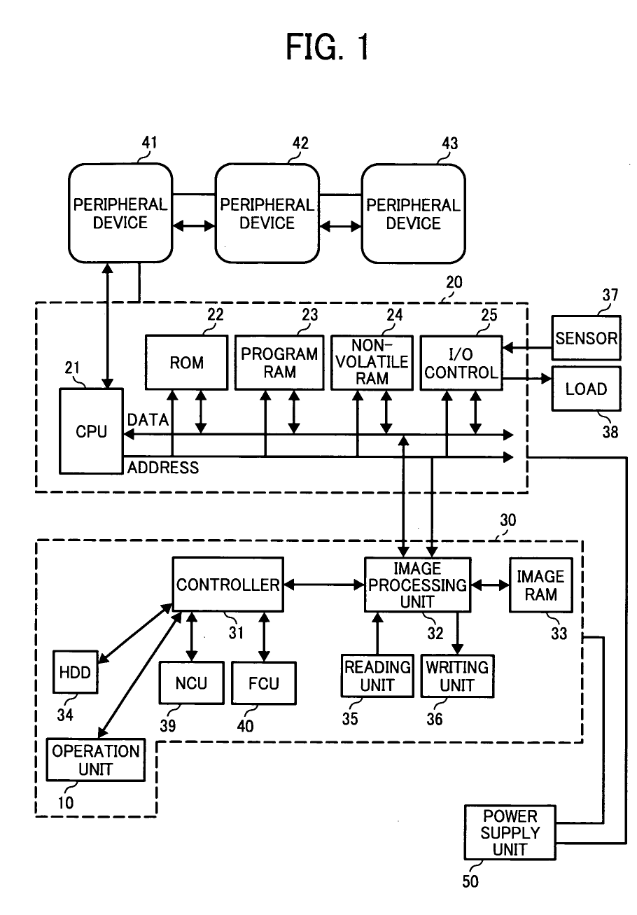

FIG. 1 is a schematic view illustrating an example of a configuration of an image forming apparatus according to exemplary embodiments. The image forming apparatus has a power saving mode to reduce power consumption during standby.

Referring to FIG. 1, an engine control unit 20 includes a central processing unit (CPU) 21; a read-only memory (ROM) 22 configured to store programs for operating the CPU 21; a program random access memory (RAM) 23; a nonvolatile RAM 24 capable of storing data such as adjusted values for control and timing, and settings of a registered copy mode, even after the image forming apparatus is turned off; and an I/O control 25 configured to control a load 38 and so forth based on data input from a sensor 37.

The engine control unit 20 is connected to a controller control unit 30 via an image processing unit 32. Control signals and status signals as well as image data are exchanged between the engine control unit 20 and the controller control unit 30 via the image processing unit 32. When the image forming apparatus is turned on, copying may be performed by the image forming apparatus after both the engine control unit 20 and the controller control unit 30 have been initialized.

A reading unit 35 reads image data, and the image processing unit 32 performs MTF correction, scaling, image quality correction, and so forth for the image data thus read based on a mode set in an operation unit 10. Thereafter, the image data is stored in an image RAM 33 and an HDD 34 via a controller 31 configured to control the HDD 34.

When an electronic sorting function is used to print a plurality of copies, the image data stored in the HDD 34 is copied to the image RAM 33 to print second and subsequent copies. The image data stored in the HDD 34 is also used when printing is restarted after suspension caused by a paper jam. A writing unit 36 prints the image data on a sheet as the sheet is supplied.

The controller control unit 30 further includes a network control unit (NCU) 39 configured to connect to an external host, and a facsimile control unit (FCU) 40 configured to perform a facsimile function through a public network. When a print job or a facsimile is received from an external PC, such data is converted into print data by the controller 31, and the print data is temporarily stored in the HDD 34. Thereafter, the print data is sent to the writing unit 36 through the image processing unit 32 so that the print data is printed on a sheet in a similar way as described above. The controller control unit 30 further includes the operation unit 10 including a user interface (UI) used when a user operates the image forming apparatus.

Power is separately supplied to the engine control unit 20 and the controller control unit 30 from a power supply unit 50, and further supplied to a peripheral device 41 through the engine control unit 20. Power is supplied to peripheral devices 42 and 43 in series from the peripheral device 41.

The peripheral device 41 and the CPU 21 of the engine control unit 20 are electrically connected to each other. The CPU 21 sends instructions to the peripheral device 41, and the peripheral device 41 sends results or states to the engine control unit 20 through the CPU 21. The peripheral device 41 exchanges data with the peripheral devices 42 and 43 in series.

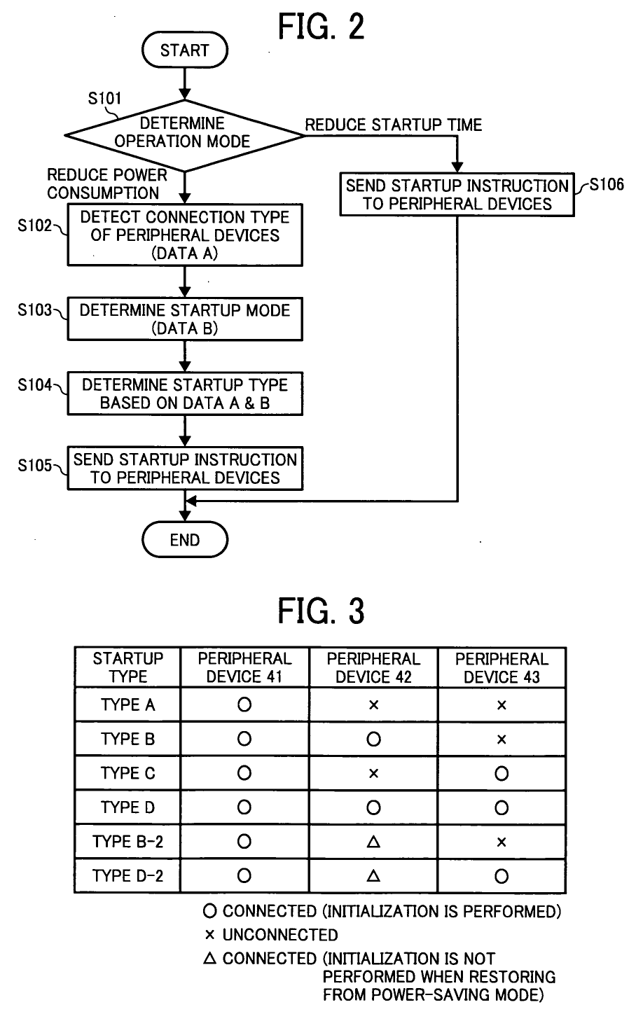

FIG. 2 is a flow chart illustrating steps performed by the engine control unit 20 to start the peripheral devices 41, 42, and 43 when the image forming apparatus is started.

At startup of the image forming apparatus, the peripheral devices 41, 42, and 43 are initialized. Thereafter, at S101, the engine control unit 20 determines whether to reduce power consumption or startup time.

When determining to reduce startup time, at S106, the engine control unit 20 sends startup instructions to the peripheral devices 41, 42, and 43 simultaneously.

Meanwhile, when determining to reduce power consumption, at S102, the engine control unit 20 detects a connection type (data A) of each of the peripheral devices 41, 42, and 43, and at S103, determines a startup mode (data B) of the image forming apparatus, which is whether the image forming apparatus is started by turning on a main power source or by restoring from a power saving mode.

Subsequently, at S104, the engine control unit 20 determines a startup type of the peripheral devices 41, 42, and 43 based on the data A and B acquired at S102 and S103 by referring to a table for determining a connection type and a startup type of the peripheral devices 41, 42, and 43 to be described in detail later. Thereafter, at S105, the engine control unit 20 sends a startup instruction to each of the peripheral devices 41, 42, and 43 at a timing determined by the startup type determined at S104.

A description is now given of a startup type of the peripheral devices.

An example of the table for determining a connection type and a startup type of the peripheral devices 41, 42, and 43 is illustrated in FIG. 3.

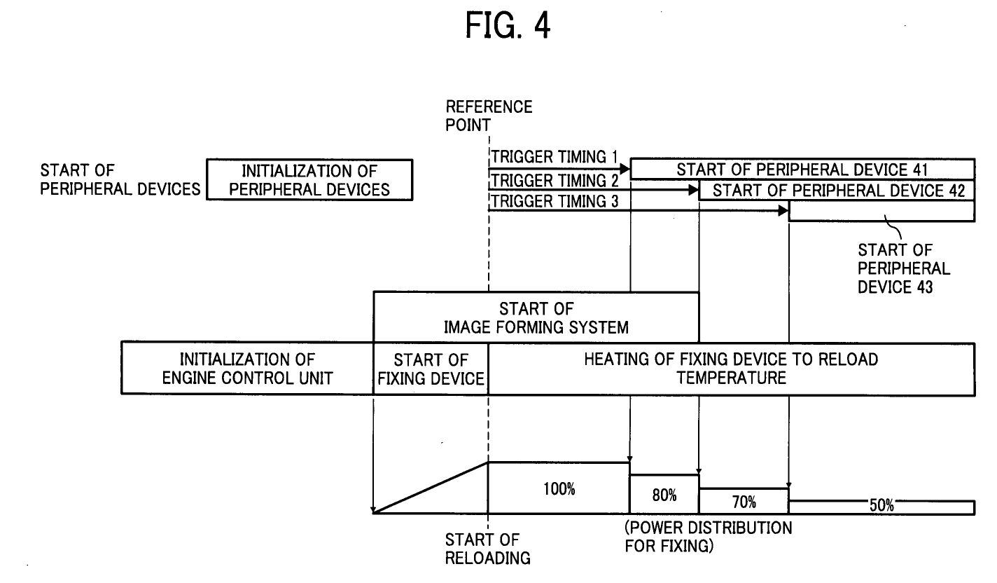

FIG. 4 is a timing chart illustrating an example of startup of the peripheral devices when the image forming apparatus is started by turning on the main power source. In the example illustrated in FIG. 4, a startup type D in the table shown in FIG. 3 is selected. Specifically, the engine control unit 20 sets an order of startup of the peripheral devices (peripheral device startup order) under a condition in which power consumption is reduced (i.e., a power saving mode) and the three peripheral devices 41, 42, and 43 are connected to the engine control unit 20.

In such a case, trigger timings 1, 2, and 3 from a reference point are respectively determined based on the startup type selected from the table shown in FIG. 3, and the engine control unit 20 sends startup instructions to the peripheral devices 41, 42, and 43 at the trigger timings 1, 2, and 3, respectively.

As a result, power distribution is controlled at each trigger timing, thereby reducing power consumption and preventing an excess of the maximum available power supply.

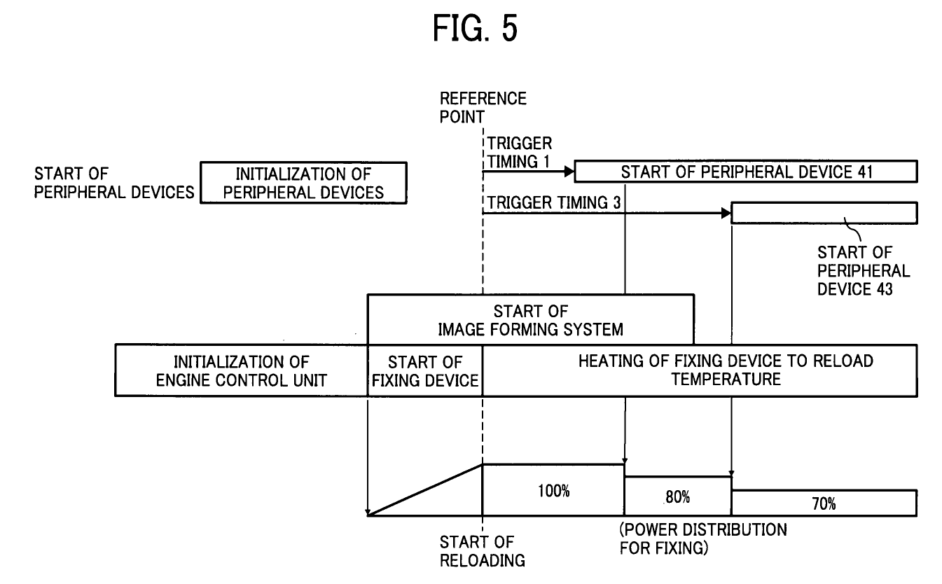

FIG. 5 is a timing chart illustrating an example of startup of the peripheral devices when the image forming apparatus is started by restoring from the power saving mode. In the example illustrated in FIG. 5, a startup type D-2 in the table shown in FIG. 3 is selected. Specifically, the engine control unit 20 sets the order of startup of the peripheral devices under a condition in which power consumption is reduced, the three peripheral devices 41, 42, and 43 are connected to the engine control unit 20, and the image forming apparatus is restored from the power saving mode.

In such a case, trigger timings 1 and 3 from a reference point are respectively determined based on the startup type selected from the table shown in FIG. 3, and the engine control unit 20 sends startup instructions to the peripheral devices 41 and 43 at the trigger timings 1 and 3, respectively.

Thus, in the present example, startup of the peripheral devices is controlled differently from the example illustrated in FIG. 4, in which the image forming apparatus is started by turning on the main power source. When the image forming apparatus is restored from the power saving mode, a peripheral device which is not required is not started. Accordingly, the startup time of the peripheral devices may be reduced while reducing power consumption.

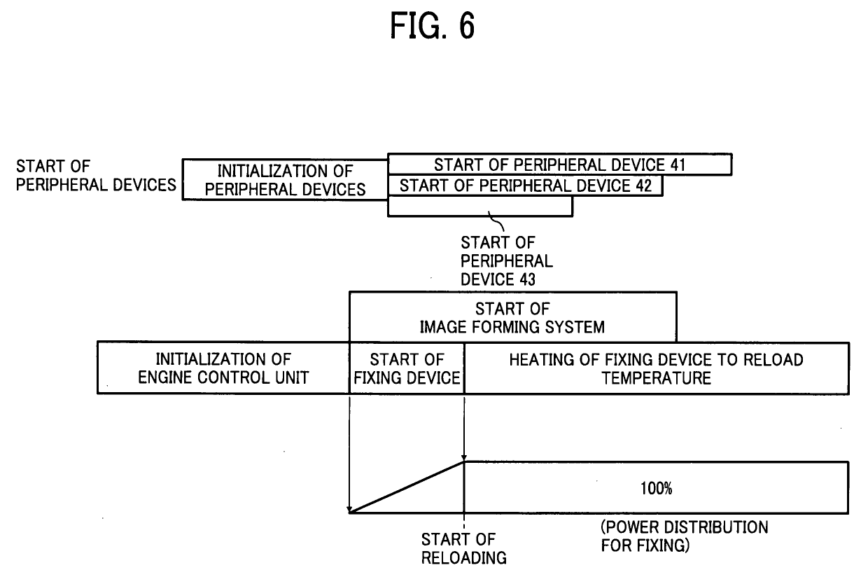

FIG. 6 is a timing chart illustrating an example of startup of the peripheral devices when the engine control unit 20 determines to reduce a startup time of the peripheral devices.

In such a case, the engine control unit 20 sends startup instructions to the peripheral devices 41, 42, and 43 simultaneously a given time after the peripheral devices 41, 42, and 43 have been initialized.

As a result, startup of the peripheral devices 41, 42, and 43 is completed immediately, thereby reducing the startup time thereof.

Therefore, startup time may be reduced more effectively in the present example when power consumption of the peripheral devices 41, 42, and 43 is not a consideration.

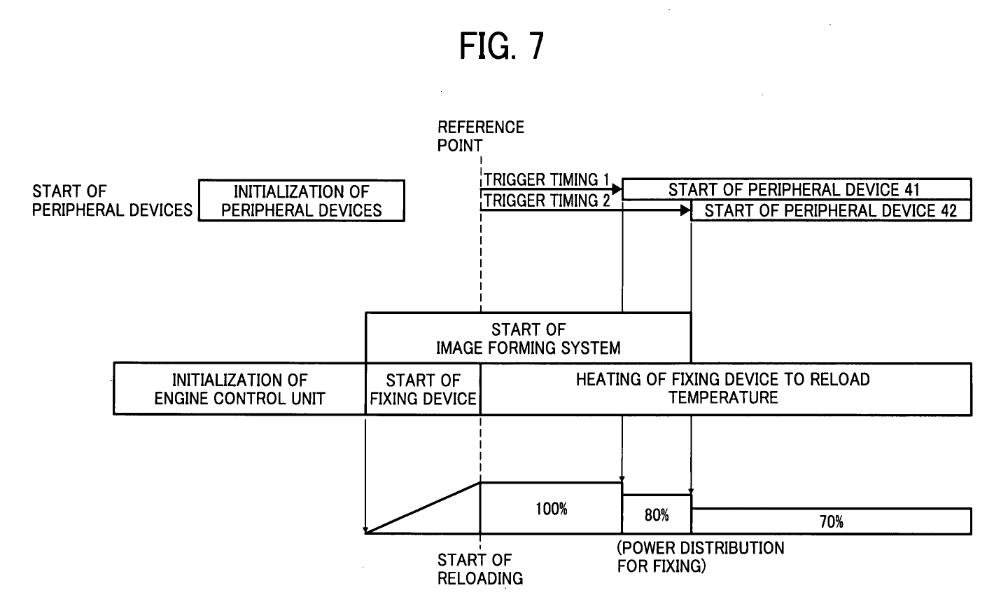

FIG. 7 is a timing chart illustrating an example of startup of the peripheral devices. In the example illustrated in FIG. 7, a startup type B in the table shown in FIG. 3 is selected. Specifically, the engine control unit 20 sets the order of start of the peripheral devices under a condition in which power consumption is reduced and the two peripheral devices 41 and 42 are connected to the engine control unit 20.

In such a case, trigger timings 1 and 2 from a reference point are respectively determined based on the startup type selected from the table shown in FIG. 3, and the engine control unit sends startup instructions to the peripheral devices 41 and 42 at the trigger timings 1 and 2, respectively.

As a result, power distribution for fixing is controlled for each trigger timing, thereby reducing power consumption and preventing an excess of the maximum available power supply.

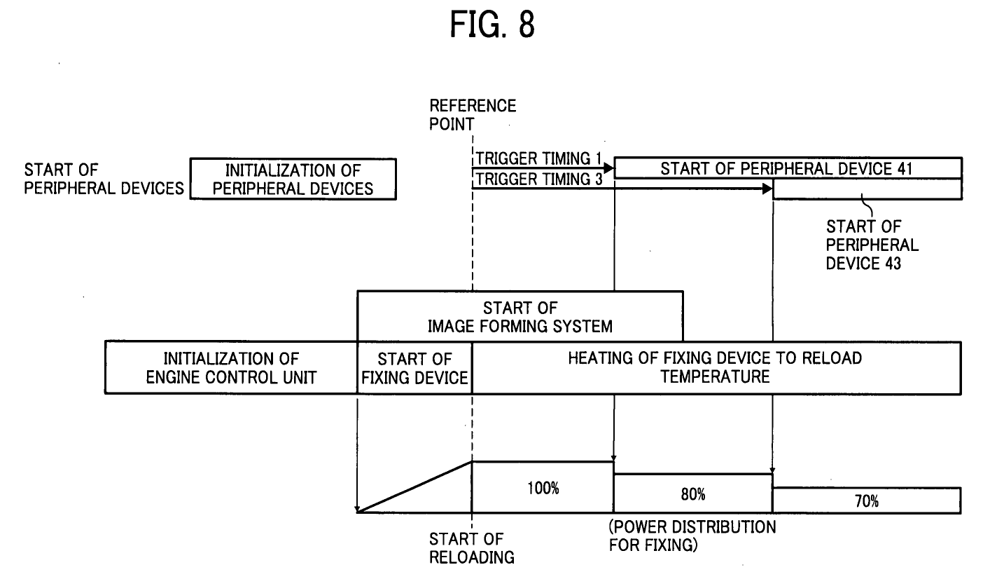

FIG. 8 is a timing chart illustrating another example of start of the peripheral devices. In the example illustrated in FIG. 8, a startup type C in the table shown in FIG. 3 is selected. Specifically, the engine control unit 20 sets the order of start of the peripheral devices under a condition in which power consumption is reduced and the two peripheral devices 41 and 43 are connected to the engine control unit 20.

In such a case, trigger timings 1 and 3 from a reference point are respectively determined based on the startup type selected from the table shown in FIG. 3, and the engine control unit 20 sends startup instructions to the peripheral devices 41 and 43 at the trigger timings 1 and 3, respectively.

As a result, power distribution is controlled at each trigger timing, thereby reducing power consumption and preventing an excess of the maximum available power supply.

It should be noted that the number of the peripheral devices connected to the engine control unit 20 is the same in the examples illustrated in FIGS. 7 and 8. However, because the type of peripheral devices connected to the engine control unit 20 is different, the trigger timing may be varied.

Thus, according to exemplary embodiments, the engine control unit 20 may send the startup instructions independently to each of the plurality of peripheral devices connected thereto in series. Accordingly, the power consumption may be controlled regardless of the type and number of peripheral devices. Furthermore, demands of the user such as reduction of power consumption and startup time may be satisfied.

Example embodiments are not limited to the details described above, and various modifications and improvements are possible without departing from the spirit and scope of example embodiments. It is therefore to be understood that, within the scope of the associated claims, example embodiments may be practiced otherwise than as specifically described herein. For example, elements and/or features of different illustrative example embodiments may be combined with each other and/or substituted for each other within the scope of example embodiments.

What is claimed is:

1. An image forming apparatus, comprising:
a controller configured to control each unit of the image forming apparatus; and
an engine, to which a startup instruction is sent from the controller and a plurality of peripheral devices is connected in series,
wherein power is supplied to the controller and the engine separately and further supplied to the plurality of peripheral devices from the engine, and the engine independently sends startup instructions to the plurality of peripheral devices.

2. The image forming apparatus according to claim 1, wherein the engine sets an order of startup of the plurality of peripheral devices based on maximum available power supply for the image forming apparatus and on power consumption by each of the plurality of peripheral devices.

3. The image forming apparatus according to claim 2, wherein the order of startup of the plurality of peripheral devices varies depending on whether the image forming apparatus is started by turning on a main power source or by restoring from a power saving mode.
